(19) United States
(12) Patent Application Publication
(10) Pub. No.: US 2002/0092943 A1
(43) Pub. Date: Jul. 18, 2002

(54) Energy absorbing seat belt retractor

(75) Inventors: Richard W. Koning, Yale, MI (US); Scott A. Willard, Rochester, MI (US)

Correspondence Address: BREED TECHNOLOGIES, INC, PATENT DEPARTMENT, 7000 NINETEEN MILE ROAD, STERLING HEIGHTS, MI, 48314

(73) Assignee: Breed Automotive Technology, Inc.

(21) Appl. No.: 10/094,290

(22) Filed: Mar. 8, 2002

Related U.S. Application Data
(63) Continuation-in-part of application No. 09/616,728, filed on Jul. 14, 2000, now abandoned.

(51) Int. Cl. B60R 22/28

(52) U.S. Cl. 242/379.1

(57) ABSTRACT

A seat belt retractor comprising: a spool about which a seat belt is wound; a locking mechanism at least initially locking the spool against rotation and a primary force-limiting mechanism, such as a torsion bar for permitting the spool to rotate in a controlled manner subsequent to the locking of the spool and a secondary force-limiting mechanism located within a recess of the spool and comprised from portions of the spool and an adjacent portion of the locking mechanism for increasing the restraining force on the seat belt before the primary force-limiting mechanism becomes effective. The torsion bar is connected at one end to the spool and at its other end to the locking mechanism. The secondary locking mechanism includes a recess, keyway or slot and a projecting, breakable tab formed on one of the bore and an interfitting part of the locking mechanism.

This application is a continuation-in-part of Ser. No. 09/616,728 filed Jul. 14, 2000.

### BACKGROUND AND SUMMARY OF THE INVENTION

The invention generally relates to seat belt retractors and more particularly to that class of seat belt retractors having an energy absorbing mechanism.

A seat belt retractor with an energy absorbing mechanism permits the seat belt to be controllably protracted from the retractor spool as a mechanism within the spool generates a determinable, somewhat level or constant, reaction force or torque to oppose the protraction. This action permits the occupant to move forwardly during an accident and lessens the crash forces exerted on the occupant. PCT patent application PCT/SE96/00472 suggests the use of an additional energy-absorbing element such as shear pins, which extend from an end face of a spool flange and connect the spool to the locking mechanism. These pins must first be shorn off in order to permit the torsion bar to work. The physical characteristics of the shear pins increase the force or torque applied to the occupant and basically introduce a peak in the force curve that corresponds to the force or energy needed to break or shear the shear pins. After the pins have been shorn off, the torsion bar is permitted to twist, generating the more constant value of reactive force dictated by the characteristics of the particular torsion bar or other type of energy-absorbing mechanism used.

One of the deficiencies of this prior art retractor is that the shear pin acts as a rivet to hold the lock mechanism to the spool and once this rivet or shear pin is torn off, the retractor loses its functionality. Additionally, in the prior design, it may be possible for a sheared or broken-off piece of the pin to lodge itself in a position within the retractor to jam the retractor.

It is an object of the present invention to provide a seat belt retractor having a primary energy-absorbing mechanism such as a torsion bar and a secondary energy-absorbing mechanism that is devoid of the above deficiencies.

Accordingly the invention comprises: a seat belt retractor comprising: a spool about which a seat belt is wound; a locking mechanism at least initially locking the spool against rotation and a primary force-limiting mechanism, such as a torsion bar for permitting the spool to rotate in a controlled manner subsequent to the locking of the spool and a secondary force-limiting mechanism located within a recess of the spool and comprised from portions of the spool and an adjacent portion of the locking mechanism for increasing the restraining force on the seat belt before the primary force-limiting mechanism becomes effective. The torsion bar is at least partially located within a spool bore and is connected at one end to the spool and at its other end to the locking mechanism. The secondary locking mechanism includes a recess, keyway or slot and a projecting, breakable tab formed on one of a spool bore and an interfitting part of the locking mechanism. In one embodiment one set of opposingly situated tabs is used and in another embodiment a second set of tabs, shifted in space from the first set, is used.

Many other objects and purposes of the invention will be clear from the following detailed description of the drawings.

### BRIEF DESCRIPTION OF THE DRAWINGS

FIG. 1 is a cross-sectional view showing the major components of a seat belt retractor incorporating the present invention.

FIG. 2a is an end view of part of a locking mechanism.

FIG. 2b is a side view of part of the locking mechanism.

FIG. 2c is a cross-sectional view showing an alternate embodiment of the invention in which the placement of slots and pins are reversed.

FIGS. 3a, 3b and 3c show a cross-sectional, end plan and side plan view of a spool.

FIG. 4 is an assembly view showing an isometric view of the spool and locking mechanism (the lock wheel is not shown).

FIG. 5 shows various force/time (deflection) curves.

FIGS. 6a and 6b show an alternate embodiment of the invention.

FIG. 7 shows another embodiment of the invention.

### DETAILED DESCRIPTION OF THE DRAWINGS

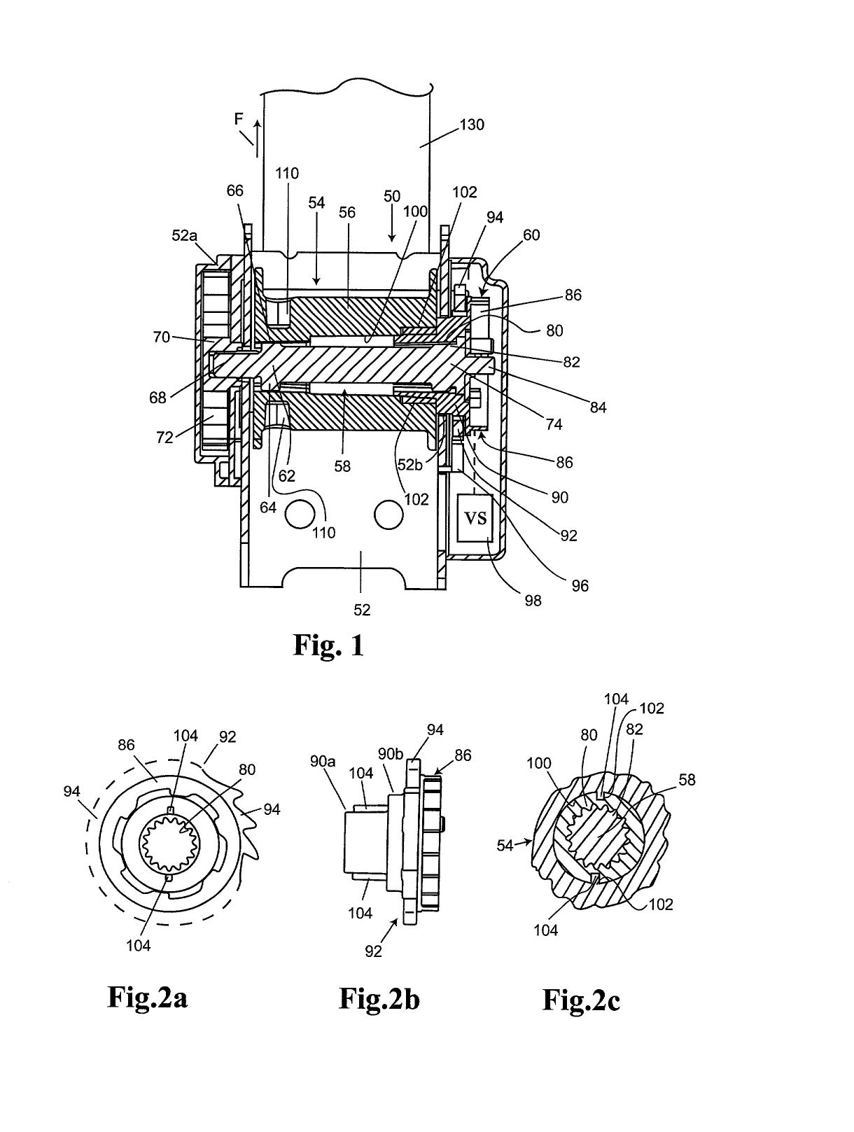

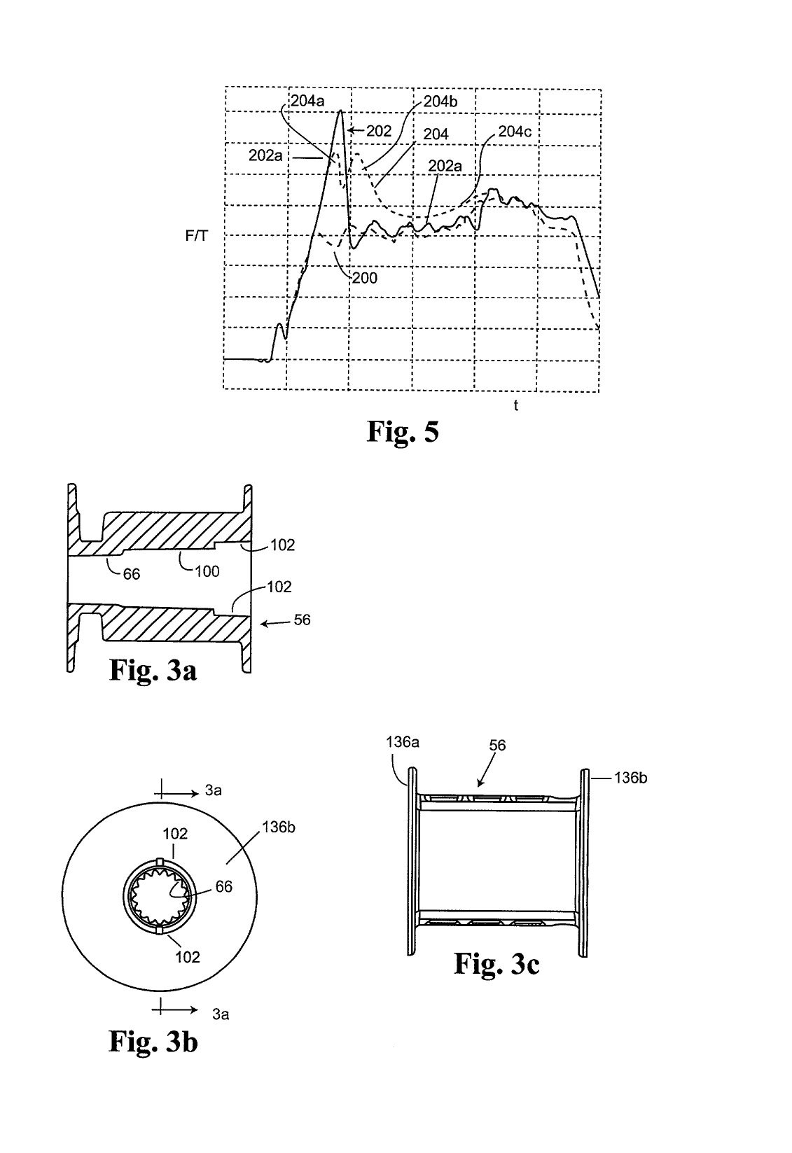

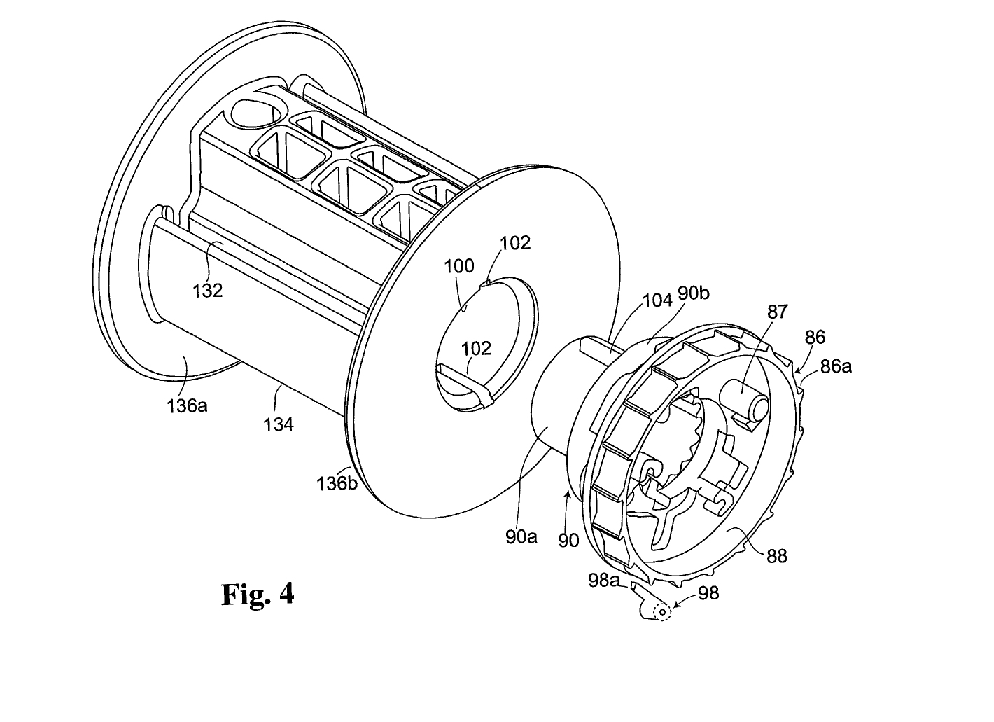

FIGS. 1-4 illustrate the major components of a seat belt retractor incorporating the present invention. The seat belt retractor 50 comprises a U-shaped frame 52 having openings 52a and 52b to support a spool and locking sub-assembly 54. These openings act as bearings. The spool and locking sub-assembly comprises a spool 56, a torsion bar 58, and a lock mechanism 60. One end 62 of the torsion bar 58 includes a plurality of splines 64, which drivingly engage a mating plurality of splines 66 formed on the torsion bar (in a known manner). An extension 68 of the torsion bar is received into a spring arbor 70 and biased by a rewind spring 72. The other end 74 of the torsion bar 58 is matingly secured to the lock wheel mechanism 60. More specifically, the mechanism 60 includes a splined bore 80, which receives splines 82 formed on end 74 of the torsion bar. This mating structure rotationally connects the torsion bar and the lock mechanism 60. The lock mechanism and torsion bar are axially fixed by swaging these parts together. The torsion bar 58 further includes an additional extension 84; the torsion bar, including this extension 84, rotates with the spool prior to activation of the torsion bar and serves as part of a known type of web sensor 86, which is schematically indicated. The lock mechanism 60 includes a ratchet wheel 86, which forms a cavity 88. The various parts of the web sensor, such as a web sensor pawl, are located within the cavity 88 (also shown in FIG. 4) formed by the ratchet wheel. Secured to the body 90 of the lock mechanism 60 is a lock wheel 92 having a plurality of teeth 94. A lock pawl 96, shown schematically, is rotationally mounted to the frame and is brought into engagement with one or more teeth 94, of the lock wheel, upon operation of the web sensor or vehicle sensor 98 in a known manner. As is known in the art, many seat belt retractors include a lock ring (not shown) that is rotatable relative to the retractor's shaft (in this case, the torsion bar); the activation of the web sensor or of a coacting vehicle sensor connects this lock ring to the retractor shaft. This action causes the lock ring to rotate a small amount and in so doing moves the lock pawl into engagement with the lock wheel. The web sensor includes an inertia disk loosely mounted to the extension 84 and a web sensor pawl (not shown) rotatably mounted to a pin 87 of the ratchet wheel 86, which in response to rapid protraction of the seat belt from the retractor spool moves to engage closely spaced teeth on the lock ring, thereby coupling the lock ring to the pawl and to the retractor shaft. The vehicle sensor 98, which can be carried by the lock ring, also includes a vehicle sensor pawl 98a, which is moved to an activated position by a movable mass (not shown) when the vehicle experiences a rapid deceleration. In the activated position the vehicle sensor pawl 98a engages the teeth 86a of the ratchet wheel 86, thereby coupling the lock ring to the retractor shaft.

Reference is made to FIG. 4, which shows that the central bore 100 of the spool 56 includes at least one slot (also referred to as a keyway) 102. The body 90 of mechanism 60 includes a plurality of projections 104 that are matingly received within the keyways 102. The projections 104 and keyways 102 drivingly connect the interior of the spool to the exterior of the body 90 of the mechanism 60. As can be seen, the body 90 includes a narrow diameter portion 90a that is received within the bore 100 of the spool and a larger diameter portion 90b that is received within and stabilized by opening, i.e. bearing, 52b in the frame.

In the embodiment illustrated, the spool also includes two bores 110 that are perpendicular to bore 100. With the torsion bar 58 in place as illustrated in FIG. 2, a tool is positioned within bores 110 and, with the application of force, locally deforms the spool so that the splines 66 of the spool remain in driving contact with the splines 64 of the torsion bar. Other means can be used to secure the torsion bar to the spool.

The spool 56 further includes a provision to receive an end of a seat belt 130. Such provision includes a known slot 132 into which an end of the belt 130 is received. Retention may be enhanced by first securing the end of the belt about a pin that fits within the slot 132. The belt is wound about the spool body 134 and retained between optional flanges 136a and 136b.

During an accident, as mentioned above, the vehicle and/or web sensor connect the lock ring (not shown) to the shaft (torsion bar) which causes the lock ring to rotate a small amount. A part of the lock ring is operatively connected to the lock pawl 96 and the rotation of the lock ring moves the lock pawl 96 into engagement with the teeth 94 of the lock wheel 92, thereby at least initially, prohibiting seat belt webbing from protracting from the spool 56. As the accident progresses, crash forces are exerted on the seat belt by the occupant, tending to try to pull the seat belt in the direction of arrow F (see FIG. 1) off from the spool 56. This force is resisted by the locking pawl and the locking pawl and lock teeth 94 interaction, as well as by the interaction between the projections 102 and the slots 104. As the level of crash forces increases to a level sufficient to cause the projections 102 to shear from the body 90a of the lock mechanism 60, a reaction force such as a reaction force of magnitude 202 (see FIG. 5) is generated. Because of the higher (see numeral 202a, FIG. 5) reaction forces generated by the slots and the pins, the occupant's forward motion will be forcefully opposed and the occupant's motion restricted. When the projections 104 are shorn off they will become lodged within a corresponding keyway, and the spool and torsion bar are free to rotate relative to the lock mechanism as continued occupant-generated forces are input to the seat belt and then to the spool. It should be appreciated the invention also includes one of the slots 102 and pins 104 rather than one set of slots and pins as shown. As can be appreciated, it is end 62 of the torsion bar that begins to twist as end 74 is held fixed to the non-rotating lock mechanism 60 (which is held by the lock pawl). As the torsion bar rotates, it will generate a lesser reaction force 202a (also see FIG. 5) which will resist the forward motion of the occupant, however, this level of force will permit the occupant to move forwardly such that the crash forces acting on the occupant are now limited based upon the characteristics of the torsion bar. As can be appreciated, one of the benefits of this type of design is that the sheared-off projections 104 are encapsulated within the spool and will not impede the functionality of the spool.

The traces in FIG. 5 show test data and more particularly belt force and a function of time (which is illustrative of belt protraction). Trace 200 shows comparative test data for a similar seat belt retractor that does not include the slots and pins.

Reference is briefly made to FIG. 2c, which shows an embodiment in which the slots are formed in the lock mechanism and the shear pins are incorporated into the spool.

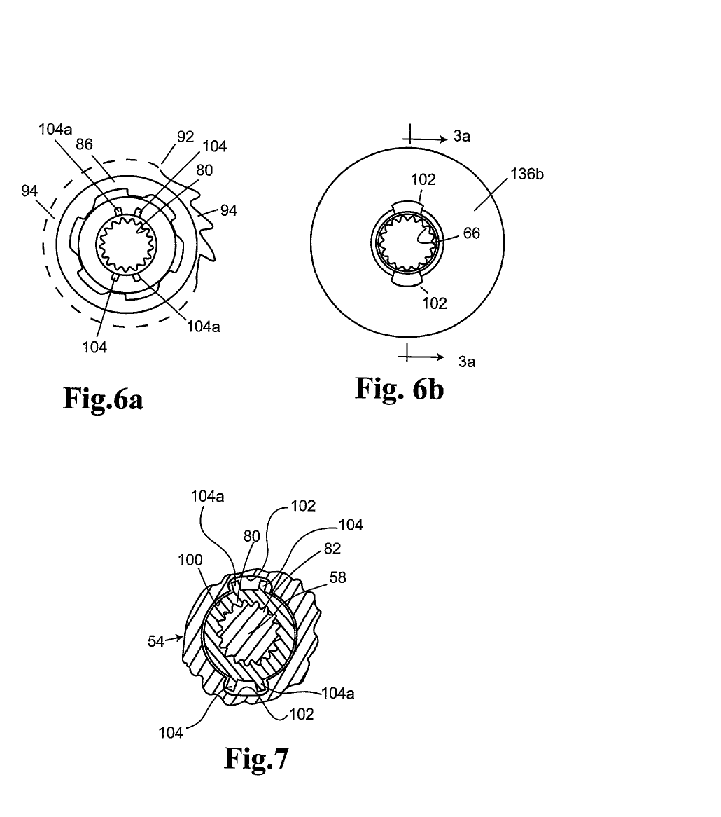

Reference is made to FIGS. 6a and 6b, which show an alternate embodiment of the invention. In this embodiment, the above set of pins 104 in the narrow diameter portion 90a of the lock mechanism 60 has been rotated by a given angle to an off-set position. In the preferred embodiment this angle is about seventeen degrees. Additionally, another set of pins 104a is located off-set at a negative angle (from null). In the preferred embodiment the angular distance between the sets of pins 104 and 104a is about thirty-seven degrees. It should be appreciated that only one pin 104 and one off-set pin 104a are part of the present invention. This embodiment however does not introduce a second set of slots but increases the width of the previously used slots (now referred to as 102a). FIG. 6c shows the two sets of projections or pins 104, 104a with a respective slot 102a (a single pin 104, 104a and single slot 102a is within the invention). The operation of this embodiment is as follows. After the spool becomes locked, the continued application of force to the seat belt applies a torque to the spool 56. At some level of force (torque) the first pin 104 or first set of pins or tabs 104 will break, this is represented as a first peak 204a (in trace 204 of FIG. 5). After the first set of tabs 104 breaks, the reaction force on the seat belt begins to drop rapidly as the spool rotates relative to the torsion bar and as the pin(s) or tab(s) 104a rotate with each respective slot 102a. The second sets of pins or tabs 104a will continue to rotate until this (or these) second tabs 104a reaches the end of a respective slot 102a or reaches the first tab 104, which may still be retained within slot 102a. Once the tab 104a or set of tabs 104a reaches the end of travel (within the slot 102a) the reaction or belt force will begin to increase (see the second peak 204b. As before, these peaks in the reaction or belt forces are greater than the level attainable by twisting the torsion bar due to the mechanical characteristics of the pins 104a. In essence, the use of the staggered or offset pins 104 and 104a (or sets of pins) in concert with the increased length slot increases the time during which an increased reaction or belt force level is sustained. As the crash forces continue to be applied to the seat belt and to the spool, the second pin 104a (or second set of pins 104a) will break, and the reaction or belt force will decrease (as the spool begins to twist the torsion bar) and the reaction force level (see section 204c of graph 204, FIG. 5) achieved is defined by the mechanical characteristics of the torsion bar.

For the sake of generality, FIG. 7 shows another alternative of the invention and is an extension of the embodiment shown in FIG. 2c. In FIG. 7 the sets of tabs 104 and 104a are now formed on the spool 56 while the complementary slots 102 are located in the narrow diameter portion 90a of the lock mechanism 60.

Many changes and modifications in the above-described embodiment of the invention can, of course, be carried out without departing from the scope thereof. Accordingly, that scope is intended to be limited only by the scope of the appended claims.

1. A seat belt retractor comprising:
a spool about which a seat belt is wound, the spool including a passage;
a locking mechanism at least initially locking the spool against rotation and a primary force-limiting mechanism, comprising a torsion bar within the passage of the spool, for permitting the spool to rotate in a controlled manner subsequent to the locking of the spool and
a secondary force-limiting mechanism comprising at least one slot and at least one interfitting, breakable member received in a respective slot, each of slot and breakable member located in the spool passage for increasing the restraining force on the seat belt before the torsion bar becomes effective;
wherein the breakable member and the slot are formed in one of the spool and the locking mechanism.

2. The apparatus as defined in claim 1 wherein the secondary force-limiting mechanism includes a first set of slots or keyways and multiple projecting, breakable tabs formed on one of the bore and an interfitting part of the locking mechanism, wherein the tabs are received within a respective slot.

3. The apparatus as defined in claim 2 wherein the multiple tabs include a first tab and a second tab off-set relative to the first tab.

4. The apparatus as defined in claim 2 wherein the multiple tabs include a first set of tabs and a second set of tabs off-set relative to the first set of tabs.

5. The apparatus as defined in claim 1 wherein the torsion bar has one end connected to the spool and another end connected to the locking mechanism.

6. The apparatus as defined in claim 1 wherein the secondary force-limiting mechanism includes opposingly located slots and breakable projections.

7. The retractor as defined in claim 1 wherein upon breaking of the breakable member, the broken member remains in the slot.

8. A seat belt retractor comprising:
a frame;
a spool rotatably mounted in the frame, the spool having a center passage and a first side and an opposite second side, the spool receiving a quantity of a seat belt therearound;
a torsion rod, having a first end received in the center passage and non-rotatably connected near the first side of the spool, the torsion bar including an opposite second end, which extends away from the second side of the spool;
a lock wheel sub-assembly including a lock wheel located outside of the spool and a hollow member surrounding the torsion bar proximate its second end, the hollow member received in the center passage proximate the second side of the spool, the second end of the torsion bar non-rotatably connected to the lock wheel sub-assembly; and
a lock pawl movable into a locking condition with the lock wheel to at least temporarily stop the lock wheel, torsion bar and spool from rotating;
the spool including at least one slot, an open side of which is directly communicated with the center passage, and wherein the lock wheel subassembly includes at least one breakable member, on an exterior surface of the hollow member, the breakable member received within the at least one slot of the spool.

9. The retractor as defined in claim 8 wherein the diameter of the exterior of the hollow member is mated to that portion of the center passage in which the hollow member is received so as to retain the breakable member within the slot, after the breakable member has broken off.

10. The retractor as defined in claim 9 wherein the spool includes a plurality of slots and the lock wheel sub-assembly includes a plurality of mating, breakable members.

11. The retractor as defined in claim 9 wherein the plurality of multiple projecting, breakable tabs includes a first set of tabs and a second set of tabs off-set from the first set of tabs and wherein a first tab of each of the first and second sets of tabs is received within a first slot and wherein a second tab of each of the first and second sets the tabs is received within a second slot.

12. A seat belt retractor comprising:
a frame;
a spool rotatably mounted in the frame, the spool having a center passage and a first side and an opposite second side, the spool receiving a quantity of a seat belt therearound;
a torsion rod, having a first end received in the center passage and non-rotatably connected near the first side of the spool, the torsion bar including an opposite second end, which extends away from the second side of the spool;
a lock wheel sub-assembly including a lock wheel located outside of the spool and a hollow member surrounding the torsion bar proximate its second end, the hollow member received in the center passage proximate the second side of the spool, the second end of the torsion bar non-rotatably connected to the lock wheel sub-assembly; and
a lock pawl movable into a locking condition with the lock wheel to at least temporarily stop the lock wheel, torsion bar and spool from rotating;
the spool including at least one breakable member extending into the center passage of the spool, and wherein the lock wheel sub-assembly includes at least one slot, on an exterior surface of the hollow member, the breakable member received within the at least one slot.

13. The retractor as defined in claim 12 wherein the diameter of the exterior of the hollow member is mated to that portion of the center passage in which the hollow member is received so as to retain the breakable member within the slot, after the breakable member has broken off.

14. The retractor as defined in claim 13 wherein the spool includes a plurality of slots and the lock wheel sub-assembly includes a plurality of mating, breakable members.

15. The retractor as defined in claim 14 wherein the plurality of multiple projecting, breakable tabs includes a first set of tabs and a second set of tabs off-set from the first set of tabs and wherein a first tab of each of the first and second sets of tabs is received within a first slot and wherein a second tab of each the first and second sets the tabs is received within a second slot.
